(19) United States
(12) Patent Application Publication
(10) Pub. No.: US 2024/0013224 A1
(43) Pub. Date: Jan. 11, 2024

(54) SYSTEM AND METHOD FOR FINANCIAL FRAUD AND ANALYSIS

(71) Applicant: Mithlesh Gupta, Noida (IN)

(72) Inventor: Nitin Kumar Goel, Harrow (GB)

(21) Appl. No.: 18/042,610

(22) PCT Filed: Jul. 16, 2021
(86) PCT No.: PCT/IB2021/056449

§ 371 Date: Feb. 23, 2023

(30) Foreign Application Priority Data
Sep. 14, 2020 (IN) 202011039726

(51) Int. Cl. G06Q 20/40; G06Q 40/08

(52) U.S. Cl. CPC G06Q 20/4016; G06Q 40/08

(57) ABSTRACT

A system and method for financial fraud and analysis is disclosed. The system includes a financial claim data processing subsystem configured to process data associated with a financial claim, a financial feature selection subsystem configured to select one or more financial features from processed data, a financial claim fraud detection subsystem configured to examine one or more values representative of the one or more financial features selected and predict a financial claim fraud, an outlier fraud detection subsystem configured to detect at least one outlier fraud using an unsupervised machine learning technique, a financial claim fraud analysis subsystem configured to analyze the financial claim fraud predicted and the at least one outlier fraud detected based on a predefined set of fraud analysis rules, a fraud amount prediction subsystem configured to predict an amount of fraud analyzed by the financial claim fraud analysis subsystem.

### EARLIEST PRIORITY DATE

This application claims priority from a Complete patent application filed in India having Patent Application No. 202011039726, filed on Sep. 14, 2020, and titled “SYSTEM AND METHOD FOR FINANCIAL FRAUD AND ANALYSIS”.

### FIELD OF INVENTION

Embodiments of a present disclosure relate to fraud analysis system, and more particularly to, a system and a method for financial fraud and analysis.

### BACKGROUND

Fraud is a crime and is also a civil law violation. Many fraud cases involve complicated financial transactions conducted by ‘white collar criminals’ such as business professionals with specialized knowledge and criminal intent. Fraudsters can contact their potential victims through many methods, which include face-to-face interaction, by post, phone calls, or electronic mails. It becomes very difficult to check identities and legitimacy of individuals and companies. Moreover, the ease with which fraudsters can divert visitors to dummy sites and steal personal financial information, the international dimensions of the web and ease with which fraudsters can hide their true location, all of this contributes to make internet fraud the fastest growing area of fraud.

Conventionally, the system, which is available for financial fraud and analysis uses rule-based solution for fraud detection. Moreover, the rules are implemented on a biannual or annual basis as its very expensive to keep replacing the rules. Further, in today's scenario one or more fraudsters keep changing their tactics to do fraud and comes up with new techniques every time, which makes it very difficult for the system to keep up with the new techniques. Therefore, it becomes too late for the system to update the rules and work with the updated techniques of the fraudsters. Moreover, updating the rules come at an additional cost which become very expensive. However, the fraud detection using the rule-based solution may sometime remain undetected which thereby makes such solution less accurate

Hence, there is a need for a system and a method for financial fraud and analysis in order to address the aforementioned issues.

### BRIEF DESCRIPTION

In accordance with an embodiment of the disclosure, a system for financial fraud detection and analysis is disclosed. The system includes one or more processors hosted on a server. The system also includes a financial claim data processing subsystem operable by the one or more processors. The financial claim data processing subsystem is configured to process data associated with the financial claim received from a claimant by using a data cleaning technique and a data pre-processing technique respectively. The system also includes a financial feature selection subsystem operable by the one or more processors. The financial feature selection subsystem is configured to select one or more financial features from processed data associated with the financial claim using a feature selection technique.

The system also includes a financial claim fraud detection subsystem operable by the one or more processors. The financial claim fraud detection subsystem is configured to examine one or more values representative of the one or more financial features selected for computation of a fraud rate. The financial claim fraud detection subsystem is also configured to predict a financial claim fraud based on a combination of an existing fraud detection technique and the financial claim fraud ring detected. The system also includes an outlier fraud detection subsystem operable by the one or more processors. The outlier fraud detection subsystem is configured to detect at least one outlier fraud in the processed data associated with the financial claim based on prediction of the financial claim fraud using an unsupervised machine learning technique. The system also includes a financial claim fraud analysis subsystem operable by the one or more processors. The financial claim fraud analysis subsystem is configured to analyze the financial claim fraud predicted and the at least one outlier fraud detected based on a pre-defined set of fraud analysis rules for investigation of a fraudulent financial transaction. The system also includes a fraud amount prediction subsystem operatively coupled to the one or more processors, wherein the fraud amount prediction subsystem is configured to predict an amount of fraud analyzed by the financial claim fraud analysis subsystem.

In accordance with another embodiment of the disclosure, a method for financial fraud and analysis is disclosed. The method includes processing data associated with the financial claim received from a claimant by using a data cleaning technique and a data pre-processing technique respectively. The method includes selecting one or more financial features from processed data associated with the financial claim using a feature selection technique. The method includes examining one or more values representative of the one or more financial features selected for computation of a fraud rate. The method includes detecting a financial claim fraud ring based on one or more financial fraud detection techniques. The method includes predicting a financial claim fraud based on a combination of an existing fraud detection technique and the financial claim fraud ring detected. The method includes detecting at least one outlier fraud in the processed data associated with the financial claim based on prediction of the financial claim fraud using an unsupervised learning technique. The method includes analyzing the financial claim fraud predicted and the at least one outlier fraud detected based on a pre-defined set of fraud analysis rules for investigation of a fraudulent financial transaction. The method also includes predicting an amount of fraud analyzed by the financial claim fraud analysis subsystem.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram of a financial fraud detection and analysis system for detecting one or more frauds in accordance with an embodiment of the present disclosure;

FIG. 2 is a block diagram of the financial fraud detection and analysis system for detecting the one or more frauds of FIG. 1 in accordance with an embodiment of the present disclosure;

FIG. 3 represents selection of the one or more financial features for training models, in accordance with an embodiment of the present disclosure;

FIG. 4 illustrates an option for setting for feature selection in the system, in accordance with an embodiment of the present disclosure;

FIG. 5 depicts a scenario of system assisting the user in understanding importance of the selected or deselected features via graphical visualisation during the process of feature selection, in accordance with an embodiment of the present disclosure;

FIG. 6 illustrates an instance of fraud detection based on the analysed historical data associated with the financial claim, in accordance with an embodiment of the present disclosure;

FIG. 7 is an exemplary embodiment representing a block diagram of the system for financial fraud and analysis of FIG. 2 in accordance with an embodiment of the present disclosure;

FIG. 8 is a block diagram of fraud analysis computer system or a server in accordance with an embodiment of the present disclosure; and

FIGS. 9A and 9B are flow diagrams representing steps involved in a method for financial fraud and analysis in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprise”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and method for financial fraud and analysis. The system includes one or more processors. The system also includes a financial claim data processing subsystem operable by the one or more processors. The financial claim data processing subsystem is configured to process data associated with the financial claim received from a claimant by using a data cleaning technique and a data pre-processing technique respectively. The system also includes a financial feature selection subsystem operable by the one or more processors. The financial feature selection subsystem is configured to select one or more financial features from processed data associated with the financial claim using a feature selection technique.

The system also includes a financial claim fraud detection subsystem operable by the one or more processors. The financial claim fraud detection subsystem is configured to examine one or more values representative of the one or more financial features selected for computation of a fraud rate. The financial claim fraud detection subsystem is also configured to predict a financial claim fraud based on a combination of an existing fraud detection technique and the financial claim fraud ring detected. The system also includes an outlier fraud detection subsystem operable by the one or more processors. The outlier fraud detection subsystem is configured to detect at least one outlier fraud in the processed data associated with the financial claim based on prediction of the financial claim fraud using an unsupervised machine learning technique. The system also includes a financial claim fraud analysis subsystem operable by the one or more processors. The financial claim fraud analysis subsystem is configured to analyze the financial claim fraud predicted and the at least one outlier fraud detected based on a pre-defined set of fraud analysis rules for investigation of a fraudulent financial transaction. The system also includes a fraud amount prediction subsystem operatively coupled to the one or more processors, wherein the fraud amount prediction subsystem is configured to predict an amount of fraud analyzed by the financial claim fraud analysis subsystem.

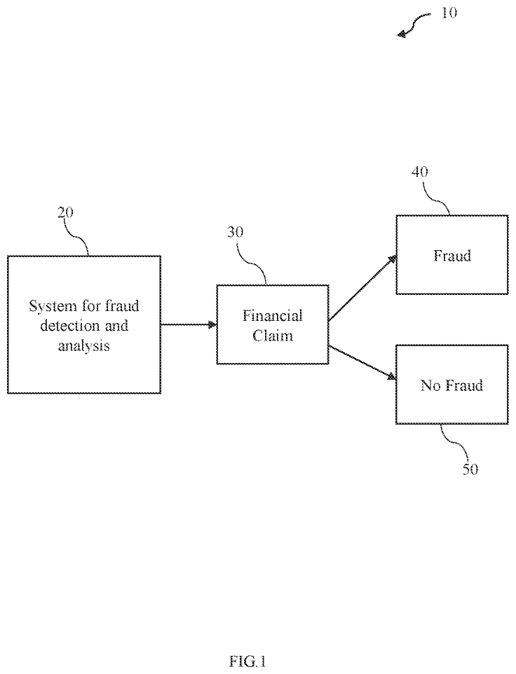

FIG. 1 is a block diagram of a financial fraud detection and analysis system (10) for detecting one or more frauds (40) in accordance with an embodiment of the present disclosure. The system (10) predicts if a financial claim 30) of a claimant is a fraud or not. In such embodiment, the one or more frauds (40) may include, but not limited to, one or more credit card frauds, one or more health insurance frauds, one or more home insurance frauds, one or more life insurance frauds, one or more small medium enterprise (SME) loan frauds, one or more travel insurance frauds, one or more vehicle insurance frauds, one or more vehicle financing frauds and the like.

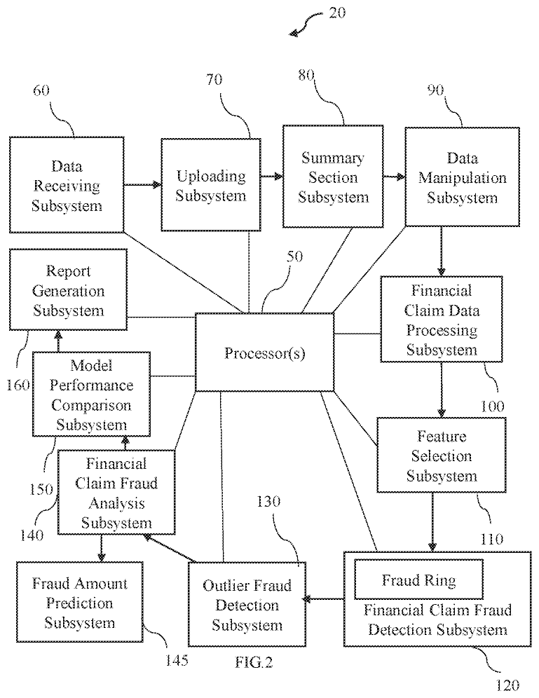

FIG. 2 is a block diagram of a financial fraud detection and analysis system (10) for detecting the one or more frauds of FIG. 1 in accordance with an embodiment of the present disclosure. The system (20) includes one or more processors (50) hosted on a server. In such embodiment, the server may include a cloud server. In one embodiment, the system (20) may include a data receiving subsystem (60) operable by the one or more processors (50). The data receiving subsystem (60) receives data associated with the financial claim from the claimant. In such embodiment, the financial claim may include, but not limited to, data associated with at least one of an insurance claim, the data associated with an insurance application, the data associated with a loan claim data, the data associated with a credit card claim data, the data associated with a combination thereof and the like.

In one embodiment, the system (20) may include an uploading subsystem (70) operable by the one or more processors (50). In such embodiment, the uploading subsystem (70) enables a user to upload the data associated with the financial claim received by the data receiving subsystem (60) on the server. In such embodiment, the user may include a person using the financial fraud detection and analysis system (20) for detecting one or more frauds. In one embodiment, the data receiving subsystem (60) may enable the user to select a format of the data associated with the financial claim. In such embodiment, the format may include, but not limited to, a word file, a portable document format file, a comma separated values file and the like. In one embodiment, the data associated with the financial claim may be viewed by the user upon uploading the data associated with the financial claim on the server.

Further, in one embodiment, the system (20) may include a summary section subsystem (80) operable by the one or more processors (50). The summary section subsystem (80) displays an overview of the data associated with the financial claim, a first set of variables associated with the data associated with the financial claim received by the data receiving subsystem (60). In such embodiment, the first set of variables may include one or more numeric variables, one or more-character variables and the like. Further, in some embodiment, the system (20) may include a data manipulation subsystem (90) operable by the one or more processors (50). In such embodiment, the data manipulation subsystem (90) manipulates the data associated with the financial claim received by the data receiving subsystem (60) by using one or more filters. In such embodiment, the one or more filters may include, but not limited to, deletion of one or more columns, defining one or more categorical variables, filtering one or more columns, creation of a second set of variables and the like. In such embodiment, the second set of variables may include one or more new variables and the like. In one embodiment, the data manipulation subsystem (90) may display an original size of the data associated with the financial claim as well as a filtered data associated with the financial claim.

Further, the system (20) includes a financial claim data processing subsystem (100) operable by the one or more processors (50). The financial claim data processing subsystem (100) processes data associated with the financial claim received from the data receiving subsystem (60) by using a data cleaning technique and a data pre-processing technique respectively. In such embodiment, the data cleaning technique may include, but not limited to, at least one of a merging operation of one or more tables of the received data associated with the financial claim, a data associated with the financial claim transformation operation, a missing value treatment operation of the data associated with the financial claim, a data associated with the financial claim normalization operation, a constant financial feature removal operation, a combination thereof and the like.

Further, in such embodiment, the data pre-processing technique may include, but not limited to, at least one of financial feature extraction process, a financial feature encoding process, a splitting process of the received data associated with the financial claim, a financial feature scaling process of the received data associated with the financial claim, a combination thereof and the like. In an embodiment the financial features includes months as customer; age of customer, policy deductible, policy annual premium, umbrella limit, sex education level, occupation, hobbies, relationship, capital gains, capital loss, incident type, collision type, incident severity, authorities contacted, incident state, incident city, incident location, incident hour of the day, number of vehicles involved, property damage, bodily injuries, witnesses, police report available, total claim amount, injury claim, property claim, vehicle claim, auto/car/vehicle make, fraud reported, and number of times fraud reported.

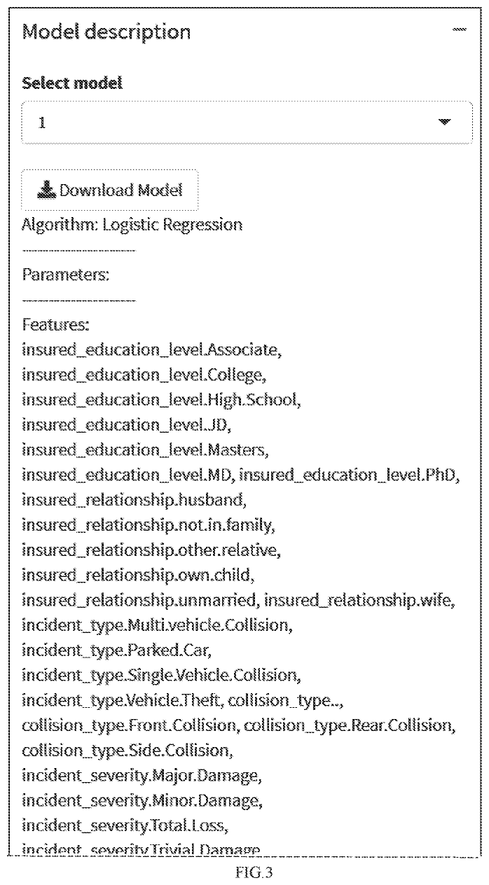

The system (20) also includes a financial feature selection subsystem (110) operable by the one or more processors (50). The feature selection subsystem (110) selects one or more financial features from processed data associated with the financial claim using a feature selection technique. In such embodiment, the one or more financial features may include, but not limited to, at least one of customer demographics data, fraud history, claim amount, financial claim corresponding details, incident details, a combination thereof and the like. FIG. 3 represents selection of the one or more financial features for training models in accordance with an embodiment of the present disclosure.

In one specific embodiment, the system (20) may include a graphical analysis subsystem operable by the one or more processors (50). The graphical analysis subsystem may analyze the data associated with the financial claim by using one or more graphs. In such embodiment, the one or more graphs may include, but not limited to, a one-variable graph, a two-variable graph and the like. In one embodiment, the graphical analysis subsystem may include selecting a chart type for the one or more graphs.

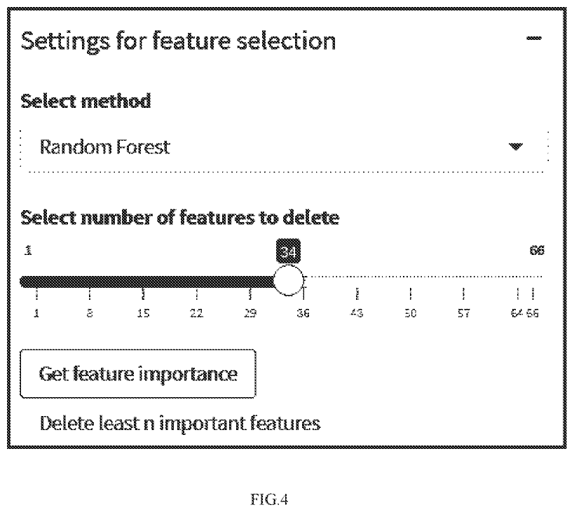

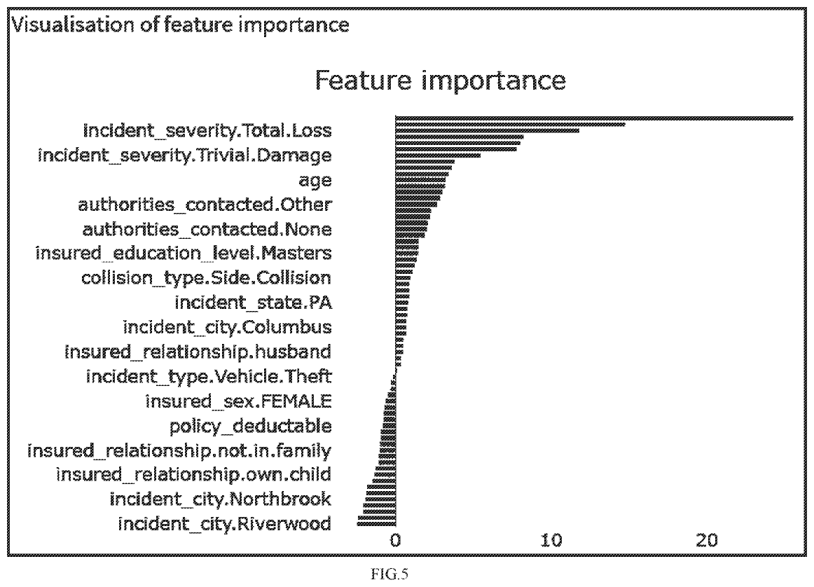

The system (20) includes a financial claim fraud detection subsystem (120) operable by the one or more processors (50). The financial claim fraud detection subsystem (120) examines one or more values representative of the one or more financial features selected by the financial feature selection subsystem (110) for computation of a fraud rate. In an embodiment, the system (100) provides an option for setting for feature selection as illustrated in FIG. 4. During the process of feature selection, the system (100) also assists the user in understanding importance of the selected or deselected features via graphical visualisation as illustrated in FIG. 5. Further, the financial claim fraud detection subsystem (120) also detects the financial claim fraud ring based on one or more financial claim fraud detection techniques. In one embodiment, the one or more financial claim fraud detection techniques may include detection based on the fraud rate computed by utilization of a fraud detection model implemented using an unsupervised learning technique, based on the fraud rate computed by utilization of a fraud detection model implemented using a machine learning technique and the like. In one embodiment, the claimant may always be a part of the fraud ring if the claimant has done the fraud in a past.

In another embodiment, if the claimant has not done any fraud in the past and applied for a claim then the claimant may not be the part of the fraud ring. In one specific embodiment, the fraud ring may be detected by setting a target variable. In one embodiment, the financial claim fraud detection subsystem (120) may verify if a predicted fraud rate is in sync with an actual fraud rate. In one embodiment, the financial claim fraud detection subsystem may monitor performance of the system by comparing the predicted fraud rate and the actual fraud rate. In some embodiment, the fraud ring may use an associative property to detect one or more claimants. In one exemplary embodiment, if ‘a’ and ‘b’ are a part of the fraud ring and ‘a’ comes with ‘c’ then they both may still be a part of the fraud ring as ‘a’ was a part of the fraud ring in the past. In some embodiment, peculiarities of the fraud ring may be highlighted.

In one specific embodiment, once the fraud ring is detected, the financial claim fraud detection subsystem (120) may look for one or more individual parameters in the data associated with the financial claim. In such embodiment, the one or more individual parameters may include, but not limited to, one or more police reports, one or more damage reports, one or more property damage reports and the like. In one embodiment, the financial claim fraud detection subsystem (120) may detect the financial claim fraud ring based on identification of a relation of the data associated with the financial claim received in real-time with a previous fraudulent claim detected.

Further, the financial claim fraud detection subsystem (120) predicts a financial claim fraud based on a combination of an existing fraud detection technique and the financial claim fraud ring detected. In one embodiment, the existing fraud detection technique may analyze historical data associated with the financial claim to build a pre-determined fraud transaction score based on a pre-defined set of rules corresponding to an industry standard. In another embodiment, the existing fraud detection technique may detect the financial claim fraud based on a comparison of a current fraud transaction score with the pre-determined fraud transaction score.

In an embodiment of the present disclosure, the historical data associated with the financial claim include entries against following features fraud reported, insured relationship (such as husband, wife, etc.) incident type (such as multi vehicle collision, single vehicle collision, vehicle theft etc.), incident type (such as parked, stationary or moving car), collision type (such as front collision, rear collision, side collision etc.), incident severity (such as major damage, minor damage, total loss, trivial damage, etc.) authorities contacted (such as ambulance, fire, police, none, other, etc.), incident state, incident city, property damage (yes/no), police report available (yes/no), truth (yes/no), probability of truth computed, response etc.

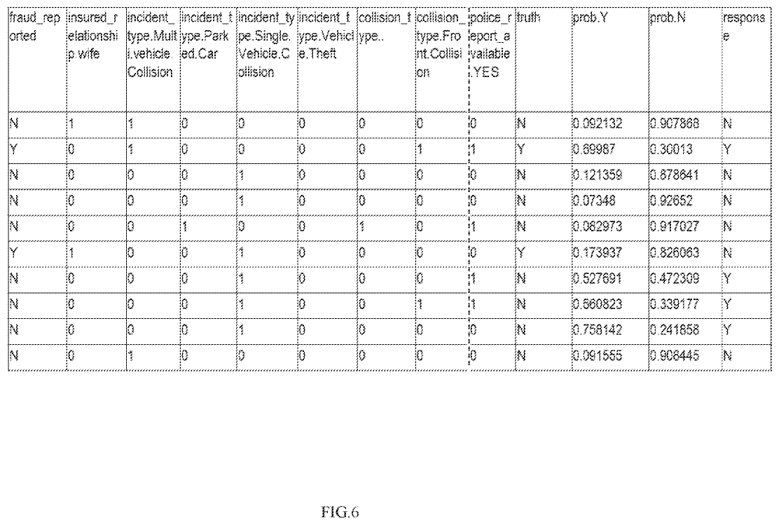

FIG. 6 illustrates an instance of fraud detection based on the analysed historical data associated with the financial claim. The table shows some of the features for representational purposes and computed probability of truth and subsequent response for the same.

Further, the system (20) includes an outlier fraud detection subsystem (130) operable by the one or more processors (50). The outlier fraud detection subsystem (130) detects at least one outlier fraud in the processed data associated with the financial claim based on prediction of the financial claim fraud using a machine learning technique. In such embodiment, the machine learning technique may include, but not limited to, an unsupervised machine learning technique. In such embodiment, the unsupervised machine learning technique, may include but not limited to, a K-means clustering and the like. As used herein, the term ‘K-means clustering’ refers to a method of vector quantization, originally from signal processing, that aims to partition n observations into k clusters in which each observation belongs to the cluster with the nearest mean. In one embodiment, the outlier fraud detection subsystem (130) may visualise the data associated with the financial claim to find one or more clusters using a graph. In some embodiment, the outlier fraud detection subsystem (130) may calculate the one or more clusters in the data associated with the financial claim and the number of the one or more clusters may be added to create a visualization of the one or more clusters. In one specific embodiment, a percentage of an outlier may depend upon the fraud rate. In one exemplary embodiment, if the fraud rate is 0.5 percent then the outlier may be 1 percent. In one embodiment, one or more input features for the fraud ring and the outlier are same. In some embodiment, the peculiarities of the outlier may be highlighted.

Further, the system (20) includes a financial claim fraud analysis subsystem (140) operable by the one or more processors (50). The financial claim fraud analysis subsystem (140) analyzes the financial claim fraud predicted and the at least one outlier fraud detected based on a pre-defined set of fraud analysis rules for investigation of a fraudulent financial transaction. In one embodiment, the system (20) may include a model development subsystem operable by the one or more processors (50). The model development subsystem develops one or more other fraud detection models by using one or more techniques. In such embodiment, the one or more techniques may include, but not limited to, a random forest technique, a gradient boost technique and the like. In one embodiment, the model development subsystem converts the one or more categorical features to the one or more numerical features by using a dummy coding. In such embodiment, the dummy coding may include one hot encoding for the one or more features. In such embodiment, the one or more categorical features may include a gender of the claimant and the like. In one specific embodiment, the dummy coding may select at least one variable from the one or more variables to skip and the encode the data associated with the financial claim.

Further, the system (20) also includes a model performance comparison subsystem (150) operable by the one or more processors (50). The model performance comparison subsystem (150) compares financial claim fraud detection performance of the fraud detection model with the one or more other fraud detection models developed by the model development subsystem based on computation of a confusion matrix. Further, in one embodiment, the model performance comparison subsystem (150) may select best working model from the one or more other fraud detection models. In some embodiment, the model performance selection subsystem (150) may delete one or more unused models. In one specific embodiment, the data associated with the one or more model may be updated monthly by using one or more machine learning techniques. In one specific embodiment, the model performance comparison subsystem (150) may calculate false negative and false positive and try to minimize the false negative and false positive to increase the performance and accuracy of the system (20).

Further, in one embodiment, the system (20) may include a fraud amount prediction subsystem operable by the one or more processors (50). The fraud amount prediction subsystem predicts an amount of fraud analyzed by the financial claim fraud analysis subsystem. In one embodiment, the fraud amount prediction subsystem may use a linear regression technique to predict the amount of the fraud. In such embodiment, the linear regression technique may use r\hat{ }2 and a mean square error method to predict the amount of the fraud. In one embodiment, an output generated by the fraud amount prediction subsystem may include one or more features. In such embodiment, the one or more features may include, but not limited to, total claim amount, umbrella limit, policy deductible, policy annual premium, injury claim, property claim, vehicle claim, fraud reported, truth, response and the like.

Further, in one exemplary embodiment, the fraud amount prediction subsystem first selects a variable. After selecting the variable, the fraud amount prediction subsystem selects an algorithm such as linear regression then after selecting the algorithm the fraud amount prediction subsystem selects a total claim amount variable as a target variable. After selecting the target variable, the fraud amount prediction subsystem selects a method for feature selection and further develops a model for the fraud amount prediction subsystem to predict the amount of the fraud.

Further, in one embodiment, the system (20) may include a report generation subsystem (160) operable by the one or more processors (50). The report generation subsystem (160) generates a plurality of periodical management reports for notification of the financial claim fraud predicted. In one embodiment, an output generated by the report generation subsystem (160) is in a form of an excel sheet. In one specific embodiment, the excel sheet may include the amount of fraud predicted, details of the fraud such as number of frauds in a pre-defined time and the like, one or more reasons of not able to detect the fraud, fraud rate prediction and the like. In one embodiment, the report generation subsystem (160) may notify whether the claim presented is fraud or not. In one embodiment, the system (20) may include a set of rules detected by the fraud ring, outliers as well as the one or more models. In one embodiment, the set of rules may be implemented in the excel sheet. In another embodiment, the set of rules may be implemented in a rule engine. In such embodiment, the rule engine may be used to provide an automatic response.

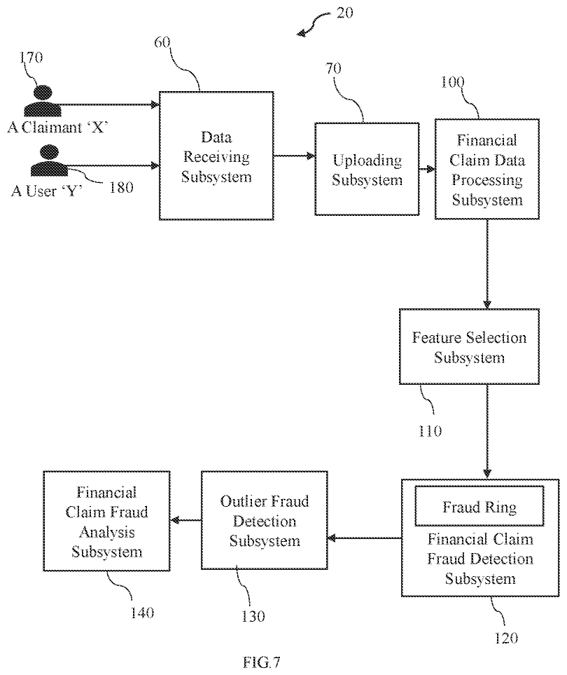

FIG. 7 is an exemplary embodiment representing a block diagram of the system (20) for financial fraud and analysis of FIG. 2 in accordance with an embodiment of the present disclosure. The system (20) receives the data associated with the financial claim by a claimant ‘X’ (170), by the data receiving subsystem (60). After receiving, the data associated with financial claim is uploaded by a user ‘Y’ (180) on the server by selecting a format as CSV, by the uploading subsystem (70). Further, the data associated with the financial claim received by the claimant ‘X’ (170) is processed by using a data cleaning technique and a data pre-processing technique respectively by the financial claim data processing subsystem (100).

After processing, the user ‘Y’ (180) selects one or more financial features from processed data associated with the financial claim using a feature selection technique by the financial feature selection subsystem (110). For example, the user ‘Y’ (180) selects at least one financial feature such as customer demographics data, fraud history, claim amount, financial claim corresponding details, incident details or a combination thereof. Further, a financial claim fraud ring based on the fraud rate computed by utilization of a fraud detection model implemented using a K-means algorithm, by the financial claim fraud detection subsystem (120). Further, an outlier fraud is detected in the processed data associated with the financial claim based on prediction of the financial claim fraud, by the outlier fraud detection subsystem (130). Further, the financial claim fraud predicted is analyzed based on a pre-defined set of fraud analysis rules for investigation of a fraudulent financial transaction, by the financial claim fraud analysis subsystem (140).

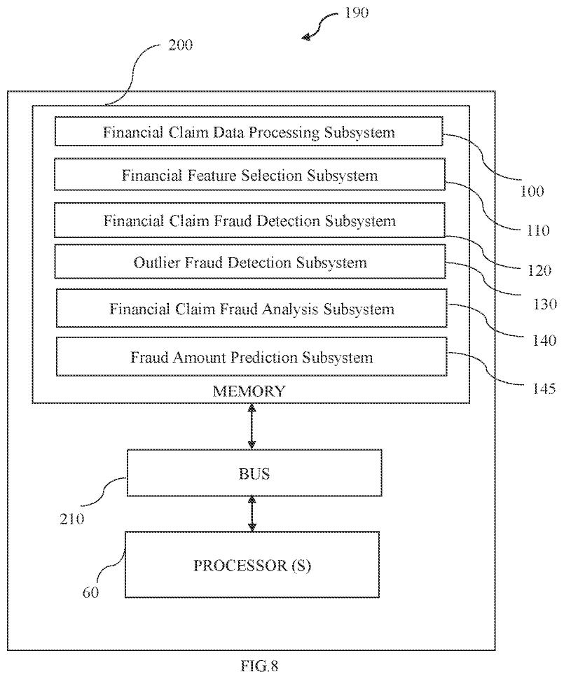

FIG. 8 is a block diagram of fraud analysis computer system or a server in accordance with an embodiment of the present disclosure. The computer system (190) includes processor(s) (50), and memory (200) coupled to the processor(s) (50) via a bus (210). The memory (200) is stored locally on a seeker device.

The processor(s) (50), as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory (200) includes multiple units stored in the form of executable program which instructs the processor (50) to perform the configuration of the system illustrated in FIG. 1. The memory (200) has following subsystems: a financial claim data processing subsystem (100), a financial feature selection subsystem (110), a financial claim fraud detection subsystem (120), an outlier fraud detection subsystem (130), a financial claim fraud analysis subsystem (140) and a fraud amount prediction subsystem (145) of FIG. 2.

Computer memory (200) elements may include any suitable memory device(s) for storing data and executable program, such as read-only memory, random access memory, erasable programmable read-only memory, electrically erasable programmable read-only memory, hard drive, removable media drive for handling memory cards and the like. Embodiments of the present subject matter may be implemented in conjunction with program subsystems, including functions, procedures, data structures, and application programs, for performing tasks, or defining abstract data types or low-level hardware contexts. The executable program stored on any of the above-mentioned storage media may be executable by the processor(s) (50).

The financial claim data processing subsystem (100) instructs the processor(s) (50) to process data associated with the financial claim received from a claimant by using a data cleaning technique and a data pre-processing technique respectively. The financial feature selection subsystem (110) instructs the processor(s) (50) to select one or more financial features from processed data associated with the financial claim using a feature selection technique. The financial claim fraud detection subsystem (120) instructs the processor(s) (50) to examine one or more values representative of the one or more financial features selected for computation of a fraud rate.

The financial claim fraud detection subsystem (130) instructs the processor(s) (50) to predict a financial claim fraud based on a combination of an existing fraud detection technique and the financial claim fraud ring detected. The outlier fraud detection subsystem (130) instructs the processor(s) (50) to detect at least one outlier fraud in the processed data associated with the financial claim based on prediction of the financial claim fraud using an unsupervised machine learning technique. The financial claim fraud analysis subsystem (140) instructs the processor(s) (50) to analyze the financial claim fraud predicted and the at least one outlier fraud detected based on a predefined set of fraud analysis rules for investigation of a fraudulent financial transaction. The fraud amount prediction subsystem (145) instructs the processor(s) (50) to predict an amount of fraud analyzed by the financial claim fraud analysis subsystem.

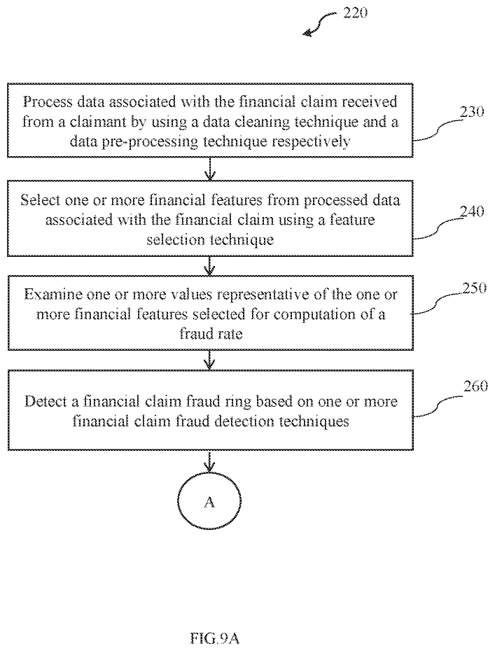

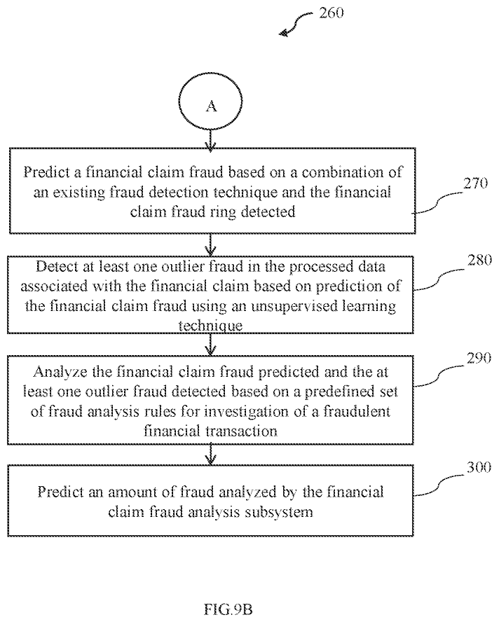

FIGS. 9A and 9B are flow diagrams representing steps involved in a method (220) for financial fraud and analysis in accordance with an embodiment of the present disclosure. The method (220) includes receiving, by a data receiving subsystem, data associated with the financial claim from the claimant. In such embodiment, receiving the financial claim may include, receiving data associated with at least one of an insurance claim, the data associated with an insurance application, the data associated with a loan claim data, the data associated with a credit card claim data, the data associated with a combination thereof and the like.

In one embodiment, the method (220) may include enabling, by an uploading subsystem, a user to upload the data associated with the financial claim received by the data receiving subsystem on the server. In such embodiment, enabling the user may include enabling a person using the financial fraud detection and analysis system (10) for detecting one or more frauds. In one embodiment, the method (220) may include selecting a format of the data associated with the financial claim by the user. In such embodiment, selecting the format may include selecting a word file, a portable document format file, a comma separated values file and the like. In one embodiment, the method (220) may include viewing the data associated with the financial claim on the server by the user upon uploading.

Further, in one embodiment, the method (220) may include displaying, a summary section subsystem, an overview of the data associated with the financial claim, a first set of variables associated with the data associated with the financial claim received by the data receiving subsystem. In such embodiment, displaying the first set of variables may include displaying one or more numeric variables, one or more-character variables and the like. Further, in some embodiment, the method (220) may include manipulating, by a data manipulation subsystem, the data associated with the financial claim received by the data receiving subsystem by using one or more filters. In such embodiment, using the one or more filters may include using deletion of one or more columns, defining one or more categorical variables, filtering one or more columns, creation of a second set of variables and the like. In such embodiment, using the second set of variables may include using one or more new variables and the like. In one embodiment, the method (220) may include displaying an original size of the data associated with the financial claim as well as a filtered data associated with the financial claim.

Further, the method (220) includes processing, a financial claim data processing subsystem, data associated with the financial claim received from the data receiving subsystem by using a data cleaning technique and a data pre-processing technique respectively in step 230. In such embodiment, using the data cleaning technique may include using at least one of a merging operation of one or more tables of the received data associated with the financial claim, a data associated with the financial claim transformation operation, a missing value treatment operation of the data associated with the financial claim, a data associated with the financial claim normalization operation, a constant financial feature removal operation, a combination thereof and the like.

Further, in such embodiment, the method (220) may include using the data pre-processing technique may include using at least one of financial feature extraction process, a financial feature encoding process, a splitting process of the received data associated with the financial claim, a financial feature scaling process of the received data associated with the financial claim, a combination thereof and the like. The method (220) includes selecting, a feature selection subsystem, one or more financial features from processed data associated with the financial claim using a feature selection technique in step 240. In such embodiment, selecting the one or more features may include selecting at least one of customer demographics data, fraud history, claim amount, financial claim corresponding details, incident details, a combination thereof and the like.

In one specific embodiment, the method (220) may include analyzing, by a graphical analyzing subsystem, the data associated with the financial claim by using one or more graphs. In such embodiment, using the one or more graphs may include using a one-variable graph, a two-variable graph and the like. In one embodiment, the method may include selecting a chart type for the one or more graphs.

Further, the method (220) includes examining, a financial claim fraud detection subsystem, one or more values representative of the one or more financial features selected by the financial feature selection subsystem for computation of a fraud rate in step 250. Further, the method (220) includes detecting, by the financial claim fraud detection subsystem, the financial claim fraud ring based on one or more financial claim fraud detection techniques in step 260. In one embodiment detecting based on the one or more fraud detection techniques may include detecting based on the fraud rate computed by utilization of a fraud detection model implemented using an unsupervised learning technique, based on the fraud rate computed by utilization of a fraud detection model implemented using a machine learning technique and the like.

In one embodiment, the method (220) may include the claimant being a part of the fraud ring if the claimant has done the fraud in a past. In another embodiment, the method (220) may include the claimant may not be the part of the fraud ring if the claimant has not done any fraud in the past. In one embodiment, the method (220) may include verifying if a predicted fraud rate is in sync with an actual fraud rate. In one embodiment, the method (220) may include monitoring performance of the system by comparing the predicted fraud rate and the actual fraud rate. In some embodiment, the method (220) may include using an associative property. In some embodiment, the method (220) may include highlighting peculiarities of the fraud ring.

In one specific embodiment, the method (220) may include looking for one or more individual parameters in the data associated with the financial claim. In such embodiment, looking for the one or more individual parameters may include looking for, one or more police reports, one or more damage reports, one or more property damage reports and the like. In one embodiment, the method (220) may include detecting the financial claim fraud ring based on identification of a relation of the data associated with the financial claim received in real-time with a previous fraudulent claim detected.

Further, the method (220) includes predicting, the financial claim fraud detection subsystem, a financial claim fraud based on a combination of an existing fraud detection technique and the financial claim fraud ring detected in step 270. In one embodiment, the method (220) may include analyzing historical data associated with the financial claim to build a pre-determined fraud transaction score based on a pre-defined set of rules corresponding to an industry standard. In another embodiment, the method (220) may include detecting the financial claim fraud based on a comparison of a current fraud transaction score with the pre-determined fraud transaction score.

Further, the method (220) includes detecting, an outlier fraud detection subsystem, at least one outlier fraud in the processed data associated with the financial claim based on prediction of the financial claim fraud using a machine learning technique in step 280. In such embodiment, using the machine learning technique may include using an unsupervised machine learning technique. In such embodiment, using the unsupervised machine learning technique may include using but not limited to, a K-means clustering and the like. In one embodiment, the method (220) may include visualising the data associated with the financial claim to find one or more clusters using a graph. In some embodiment, the method (220) may include calculating the one or more clusters in the data associated with the financial claim and the number of the one or more clusters may be added to create a visualization of the one or more clusters. In one specific embodiment, the method (220) may include depending upon the fraud rate.

Further, the method (220) includes analyzing, by a financial claim fraud analysis subsystem, the financial claim fraud predicted and the at least one outlier fraud detected based on a pre-defined set of fraud analysis rules for investigation of a fraudulent financial transaction in step 290. In one embodiment, the method (220) may include developing one or more other fraud detection models by using one or more techniques. In such embodiment, using the one or more techniques may include using a random forest technique, a gradient boost technique and the like. In one embodiment, the method (220) may include converting the one or more categorical features to the one or more numerical features by using a dummy coding. In such embodiment, using the dummy may include using one hot encoding for the one or more features. In such embodiment, converting the one or more categorical features may include using a gender of the claimant and the like. In one specific embodiment, the method (220) may include selecting at least one variable from the one or more variables to skip and the encode the data associated with the financial claim.

Further, the method (220) may include comparing, by a model performance comparison subsystem, financial claim fraud detection performance of the fraud detection model with the one or more other fraud detection models developed by the model development subsystem based on computation of a confusion matrix. Further, in one embodiment, the method (220) may include selecting best working model from the one or more other fraud detection models. In some embodiment, the method (220) may include deleting one or more unused models. In one specific embodiment, the method (220) may include updating the data associated with the one or more models monthly by using one or more machine learning techniques. In one specific embodiment, the method (220) may include calculating a false negative and a false positive and try to minimize the false negative and false positive to increase the performance and accuracy of the system (20).

Further, in one embodiment, the method (220) may include predicting, by a fraud amount prediction subsystem, an amount of fraud analyzed by the financial claim fraud analysis subsystem. In one embodiment, predicting the fraud amount may use a linear regression technique to predict the amount of the fraud. In such embodiment, using the linear regression technique may include using r\hat{ }2 and a mean square error method to predict the amount of the fraud. In one embodiment, the method (220) may include generating an output which may include one or more features. In such embodiment, generating the one or more features may include, but not limited to, generating a total claim amount, umbrella limit, policy deductible, policy annual premium, injury claim, property claim, vehicle claim, fraud reported, truth, response and the like.

Further, in one embodiment, the method (220) may include generating, by a report generation subsystem, a plurality of periodical management reports for notification of the financial claim fraud predicted. In one embodiment, the method (220) may include generating output by the report generation subsystem is in a form of an excel sheet. In one specific embodiment, generating the excel sheet may include generating the amount of fraud predicted, details of the fraud such as number of frauds in a pre-defined time and the like, one or more reasons of not able to detect the fraud, fraud rate prediction and the like. In one embodiment, the method (220) may include setting of rules detected by the fraud ring, outliers as well as the one or more models. In one embodiment, the method (220) may include implementing the set of rules in the excel sheet. In another embodiment, the method (220) may include implementing the set of rules in a rule engine. In such embodiment, the method (220) may include using the rule engine to provide an automatic response. From a technical effect point of view, the present disclosure reduces usage of hardware hence reducing the hardware expenses. Moreover, the current disclosure uses cloud storage hence reducing number of physical storages to a great extent.

Various embodiments of the present disclosure provide a technical solution to the problem for financial fraud and analysis. The present system provides an efficient system which helps programmers to use the system without any programming knowledge, thereby reduces the cost for providing training to the programmers in a specific programming language. Further, the system detects frauds based on old techniques as well as multiple new techniques. Moreover, the present disclosure detects 30 percent more frauds cases than any other solution. Further, new rules in the system are updated more frequently as a part of a subscription to the system. Moreover, depending upon client's requirement new rules are updated, which makes the system user-friendly.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A system (10) for financial fraud detection and analysis comprising:
one or more processors (50) hosted on a server;
a financial claim data processing subsystem (100) operatively coupled to the one or more processors (50), wherein the financial claim data processing subsystem (100) is configured to process data associated with the financial claim received from a claimant by using a data cleaning technique and a data pre-processing technique respectively;
a financial feature selection subsystem (110) operatively coupled to the one or more processors (50), wherein the financial feature selection subsystem (110) is configured to select one or more financial features from processed data associated with the financial claim using a feature selection technique;
a financial claim fraud detection subsystem (120) operatively coupled to the one or more processors (50), wherein the financial claim fraud detection subsystem (120) is configured to:
examine one or more values representative of the one or more financial features selected for computation of a fraud rate;
detect a financial claim fraud ring based on one or more financial claim fraud detection techniques; and
predict a financial claim fraud based on a combination of an existing fraud detection technique and the financial claim fraud ring detected;
an outlier fraud detection subsystem (130) operatively coupled to the one or more processors (50), wherein the outlier fraud detection subsystem (130) is configured to detect at least one outlier fraud in the processed data associated with the financial claim based on prediction of the financial claim fraud using an unsupervised machine learning technique;
a financial claim fraud analysis subsystem (140) operatively coupled to the one or more processors (50), wherein the financial claim fraud analysis subsystem (140) is configured to analyze the financial claim fraud predicted and the at least one outlier fraud detected based on a predefined set of fraud analysis rules for investigation of a fraudulent financial transaction; and
a fraud amount prediction subsystem (145) operatively coupled to the one or more processors (50), wherein the fraud amount prediction subsystem (145) is configured to predict an amount of fraud analyzed by the financial claim fraud analysis subsystem (140).

2. The system (20) as claimed in claim 1, wherein the server comprises a cloud server.

3. The system (20) as claimed in claim 1, wherein the data associated with the financial claim comprises at least one of an insurance claim data, an insurance application data, a loan claim data, a credit card claim data or a combination thereof.

4. The system (20) as claimed in claim 1, wherein the data cleaning technique comprises at least one of a merging operation of one or more tables of the received data associated with the financial claim, a data associated with the financial claim transformation operation, a missing value treatment operation of the data associated with the financial claim, a data associated with the financial claim normalization operation, a constant financial feature removal operation or a combination thereof.

5. The system (20) as claimed in claim 1, wherein the data pre-processing technique comprises at least one of financial feature extraction process, a financial feature encoding process, a splitting process of the received data associated with the financial claim, a financial feature scaling process of the received data associated with the financial claim or a combination thereof.

6. The system (20) as claimed in claim 1, wherein the one or more financial features comprise at least one of customer demographics data, fraud history, claim amount, financial claim corresponding details, incident details or a combination thereof.

7. The system (20) as claimed in claim 1, wherein the existing fraud detection technique is configured to:
analyze historical data associated with the financial claim to build a pre-determined fraud transaction score based on a predefined set of rules corresponding to an industry standard; and
detect the financial claim fraud based on a comparison of a current fraud transaction score with the pre-determined fraud transaction score.

8. The system (20) as claimed in claim 1, wherein the one or more financial claim fraud detection techniques comprise a first technique which is to detect the financial claim fraud ring based on identification of a relation of the data associated with the financial claim received in real-time with a previous fraudulent claim detected.

9. The system (20) as claimed in claim 1, wherein the one or more financial claim fraud detection techniques comprise a second technique which is to detect the financial claim fraud ring based on the fraud rate computed by utilization of a fraud detection model implemented using a machine learning technique.

10. The system (20) as claimed in claim 1, comprising a model performance comparison subsystem operatively coupled to the one or more processors, wherein the model performance comparison subsystem is configured to compare financial claim fraud detection performance of the fraud detection model with one or more other fraud detection models based on computation of a confusion matrix.

11. A method (220) for financial fraud detection and analysis, the method (220) comprising:
processing, by a financial claim data processing subsystem, data associated with the financial claim received from a claimant by using a data cleaning technique and a data pre-processing technique (230);
selecting, by a financial feature selection subsystem, one or more financial features from processed data associated with the financial claim using a feature selection technique (240);
examining, by a financial claim fraud detection subsystem, one or more values representative of the one or more financial features selected for computation of a fraud rate (250);
detecting, by the financial claim fraud detection subsystem, a financial claim fraud ring based on one or more financial claim fraud detection techniques (260);
predicting, by the financial claim fraud detection subsystem, a financial claim fraud based on a combination of an existing fraud detection technique and the financial claim fraud ring detected (270);
detecting, by an outlier fraud detection subsystem, at least one outlier fraud in the processed data associated with the financial claim based on prediction of the financial claim fraud using an unsupervised machine learning technique (280);
analyzing, by a financial claim fraud analysis subsystem, the financial claim fraud predicted and the at least one outlier fraud detected based on a predefined set of fraud analysis rules for investigation of a fraudulent financial transaction (290); and
predicting, by a fraud amount prediction subsystem, an amount of fraud analyzed by the financial claim fraud analysis subsystem (300).

12. The method (220) as claimed in claim 11, wherein the processing the data cleaning technique comprises processing at least one of a merging operation of one or more tables of the received data associated with the financial claim, a data associated with the financial claim transformation operation, a missing value treatment operation of the data associated with the financial claim, a data associated with the financial claim normalization operation, a constant financial feature removal operation or a combination thereof.

13. The method (220) as claimed in claim 11, wherein the selecting the one or more financial features comprises selecting at least one of customer demographics data, fraud history, claim amount, financial claim corresponding details, incident details or a combination thereof.

14. The method (220) as claimed in claim 11, wherein the detecting based on the one or more financial claim fraud detection techniques comprises detecting based on a first technique which is to detect the financial claim fraud ring based on identification of a relation of the data associated with the financial claim received in real-time with a previous fraudulent claim detected.

15. The method (220) as claimed in claim 11, wherein the detecting based on the one or more financial claim fraud detection techniques comprises a second technique which is to detect the financial claim fraud ring based on the fraud rate computed by utilization of a fraud detection model implemented using a machine learning technique.
